(19) United States
(12) Patent Application Publication
(10) Pub. No.: US 2025/0176708 A1
(43) Pub. Date: Jun. 5, 2025

(54) Smart Lectern

(71) Applicant: Keone Trask, Greenville, SC (US)

(72) Inventor: Keone Trask, Greenville, SC (US)

(21) Appl. No.: 18/959,968

(22) Filed: Nov. 26, 2024

Related U.S. Application Data
(60) Provisional application No. 63/605,067, filed on Dec. 1, 2023.

(51) Int. Cl. A47B 21/007; A47B 9/20; A47B 19/02; A47B 21/06; G06F 3/041; G06F 3/044; G06F 3/14; G09B 5/06

(52) U.S. Cl. CPC A47B 21/007; A47B 9/20; A47B 19/02; A47B 21/06; G06F 3/0416; G06F 3/044; G06F 3/14; A47B 2021/0076; A47B 2021/066; A47B 2200/0073; G09B 5/065

(57) ABSTRACT

A smart lectern system is provided. The smart lectern system comprises a smart lectern comprising a base, a mast extending from the base and a touchscreen panel attached to the mast wherein the touchscreen panel generates a touch communication. A hub is provided wherein the hub receives the touch communication and transmits a touch command to an output driver.

### CROSS-REFERENCE TO RELATED APPLICATIONS

The present application claims priority to pending U.S. Provisional Application No. 63/605,067 filed Dec. 1, 2023, which is incorporated herein by reference.

### BACKGROUND OF THE INVENTION

The present invention generally relates to digital lecterns and, more particularly, to a novel system and method for providing a smart lectern.

Educational institutions have transitioned over the past two generations away from chalkboard use, first to marker boards and now to touchscreen displays. These touchscreens comprise a digital display with internal touch sensors and an on-board computer for operation.

Lecterns used in classrooms and boardrooms are also improving. Prior art lecterns range from standalone wooden lecterns to ones that provide electronic controls for audio and video. With the advent of smart touch screen panels, lecterns are proceeding into the modern age.

Current lecterns generally do not offer a digital touchscreen. They offer only a stationary stand and, in some cases, audio controls on the stand; but no available systems offer a complete, portable, digital lectern system and method that integrates into a variety of computer systems already on-site. Often the problem with integrating audio and video for a presentation is the lack of compatibility with on-site computer systems, while at the same time there is generally a need for the presenter to use a specific type of computer for his or her presentation.

More specifically, no products offer a portable, power over ethernet (POE) powered smart lectern that integrates with a variety of computer systems. What is needed is a system and method that provides a touchscreen panel mounted on a telescoping lectern podium stand where the system is height adjustable and interactive, with a multiport hub and most importantly, integrates into any type of standard computer.

Prior art podiums are available with connections such as XLR mic inputs and outputs, separate Ethernet ports for internet connectivity, power connections, data connections, and the like. This resulted in a slew of cables that had to be run to the presenter's podium, just to make the necessary connections. Furthermore, incompatibilities limited the total functionality of the podium.

Provided herein is a smart lectern which minimizes cables and increases functionality.

### SUMMARY OF THE INVENTION

The present invention provides a complete smart lectern system comprising a touch screen panel, height adjustable podium mount, multiport hub, all operating with multiple power options including POE.

A particular feature of the invention is the reduction to only one cable to the actual lectern wherein the single cable carries power, video and audio signals, touch control, and data between the lectern and a touchscreen display wherein the lectern comprises an integrated or interfaced hub.

A particular advantage is the ability to remove the touchscreen from the base of the lectern which allows the touchscreen to be installed into a customer's own furniture or mounting solution, while still maintaining that single cable connectivity.

Another feature is mobility of smart lectern due to compact size and wheels which allows the smart lectern to be installed and used anywhere desired.

Another particular feature is the ability to preload hub software, such as Clear Touch's Collage software, for wireless screen sharing, and annotation tools for marking and notating over presentations.

The invention comprises a touchscreen panel mounted on a telescoping lectern pedestal or podium which operates on both normal AC or it may be powered by POE with a standard ethernet cable connected between a computer or hub and the lectern. It further includes input-output ports to integrate all modern communications, such as USB-A, USB-C, HDMI, audio video mini jacks, and the like.

Because the invention connects to any standard computer, the presenter may use the invention to flip through notes on the touchscreen, while simultaneously outputting a specific display to a projector or preferably larger touchscreen for the audience. In this manner, the presenter can control the presentation from a computer, the lectern touchscreen, a larger touchscreen or from an additional remote computer, through the hub.

The system may also include other communication pathways with wi-fi so that it can be used for live interactive communication with users.

One of the primary advantages provided by the invention is its small size, ease of transport, and single-cable connection to the hub, so that it may be used in assembly halls, pulpits, or even at auctions.

Currently available lecterns require multiple connections to the podium, resulting in long installation times, unorganized cable management, and the need for multiple pieces of hardware to communicate with the podium.

The present invention improves on the foregoing objects by providing a single Ethernet, RJ45 cable connection between the Podium and the hub.

The hub provides connectivity ports necessary for input and output. In an embodiment the hub comprises at least 3 HDMI Out Ports, at least one HDMI In Port, a LAN Ethernet Port and hub Ethernet Port, a POE Port for powering external POE capable devices, such as PTZ Cameras, 4 USB 2.0 Ports for Data, a USB C Port for Data, and an ⅛″ Audio Out Port. In this way, the hub can be utilized for all input and output needs, requiring only one POE connection to the Lectern itself.

A preferred embodiment of the invention utilizes the chipset, software, and EDLA Android 13 ecosystem of 6000A+ panels. This means older touchscreens panels can get a software update, OS update, and feature set upgrade all within a device that will be cheaper than a replacement. It will also save on E-waste/disposal costs of old technology.

More specifically, the invention includes a 6000A+ series computer that is capable of operation with all modern audio and video devices. It further includes a 4k camera and a 6-array microphone to provide state of the art video capabilities for any touchscreen.

Since many older touchscreen, and even newer ones, use small internal speakers that provide low-volume, low-fidelity output, the invention provides high-fidelity, high-volume amplifiers and speakers for clarity in both the classroom and boardroom.

Another advantage of the invention is that it allows for use of the NEXT microphone, which provides exceptional audio/video connectivity and clarity in both boardrooms and classrooms.

Another advantage of the invention is that it is fully EDLA-certified in both the chips and firmware. This provides a google-certified system that is far more secure. It also provides access to the google play store, more application compatibility, and management by google admin.

Another advantage of the invention is that it allows for use of the NEXT microphone, which provides exceptional audio/video connectivity and clarity in both boardrooms and classrooms.

Another advantage of the invention is that it is fully EDLA-certified in both the chip and firmware. This provides a google-certified system that is far more secure. It also provides access to the google play store, more application compatibility, and management by google admin.

A particular advantage of the invention is provided in a smart lectern system. The smart lectern system comprises a smart lectern comprising a base, a mast extending from the base and a touchscreen panel attached to the mast and capable of generating touch communication. A hub is provided wherein the hub is capable of receiving the touch communication and transmitting a touch command to an output driver.

Yet another embodiment is provided in a smart lectern system. The smart lectern system comprises a smart lectern comprising a base, a mast extending from the base and a touchscreen panel attached to the mast and capable of generating a first touch communication. The system further comprises a hub comprising in input system capable of receiving the first touch communication and a computer comprising an operating system capable of receiving the touch communication and transmitting signal output to a touch process module. The touch process module generates a touch process command. A digital display device receives the touch process command and displays an image.

### BRIEF DESCRIPTION OF THE DRAWINGS

FIG. 1 is a schematic side perspective representation of an embodiment of the invention.

FIG. 2 is a schematic front perspective representation of an embodiment of the invention.

FIG. 3 is a flow-chart representation of an embodiment of the invention.

FIG. 4 is a flow-chart representation of an embodiment of the invention.

FIG. 5 is a flow-chart representation of an embodiment of the invention.

### DESCRIPTION OF THE PREFERRED EMBODIMENTS

The present invention is a smart lectern that functions as an interface to a touchscreen digital display wherein touchscreen commands on the smart lectern are displayed on the touchscreen digital display.

The present invention provides a smart lectern providing unified communications with a variety of touchscreen digital displays. The invention comprises a modern on-board chip that functions with every known feature of current touchscreen display devices including without limitation, video, audio, microphone, and all common input/output ports.

The invention will be described with reference to the figures which are an integral part of the instant disclosure provided for clarification of the description of the invention without limit thereto. As appropriate, similar elements will be numbered accordingly.

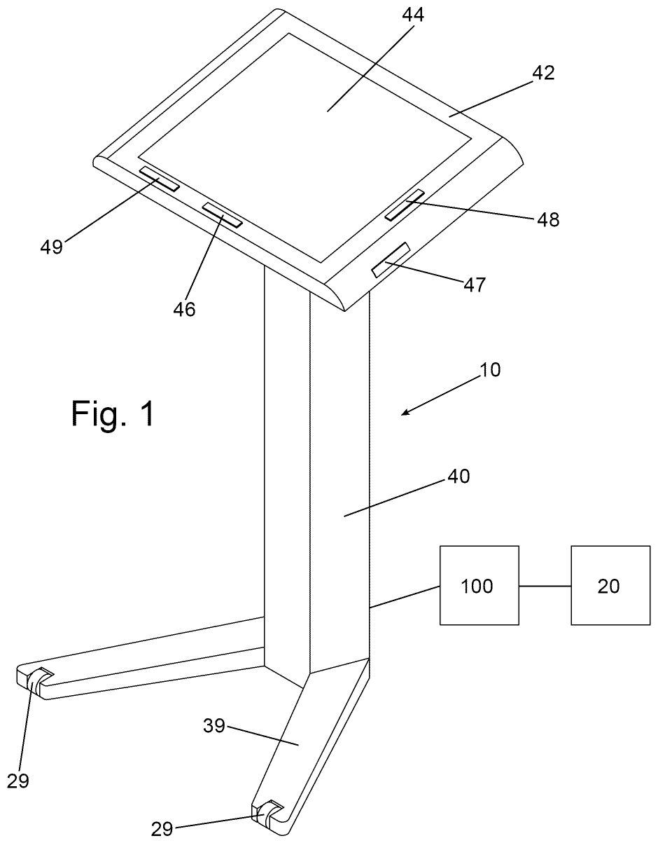

An embodiment of the invention will be described with reference to FIG. 1 illustrating a smart lectern system comprising a smart lectern, 10, which has integral thereto or interfaced thereto a hub, 100, and a touchscreen digital display, 20, in signal communication with the smart lectern. The smart lectern comprises a base, 39, with a mast, 40, which is preferably telescoping, extending upward from the base. The base preferably comprises wheels, 29, to assist in mobility. A touchscreen surface, 42, is preferably reversibly mounted to the mast. The touchscreen surface comprises a touchscreen panel, 44, integral thereto or embedded therein. A microphone, 46, which may be a two-way speaker is preferably integral to the touchscreen surface wherein the microphone can project sound through the sound system integrated with the touchscreen surface. In an embodiment the microphone may be on a flexible shaft, such as a gooseneck microphone or the microphone can be connected to the smart lectern by wireless communication. A control panel, 48, provides for control of the smart lectern and optionally the hub and touchscreen digital display. A port panel, 47, comprises the connectivity ports necessary for input and output of all necessary signals. A wireless communication link, 49, allows for wireless communication with devices such as microphones, remote controls, computers and the like.

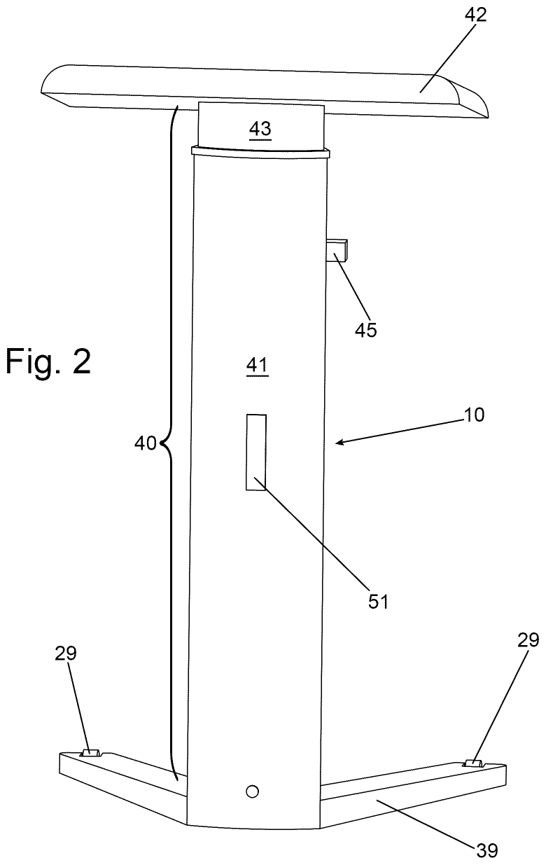

An embodiment of the invention will be described relative to FIG. 2. In FIG. 2 a smart lectern is illustrated in front perspective view. The mast, 40, comprises an upper mast, 43, and lower mast, 41, wherein the upper mast and lower mast are slidably engaged with each other and preferably telescoping. In an embodiment a lift assist, 51, such as a hydraulic lift assist is integral to said mast and persuades the upper mast and lower mast to slide relative to each other for ease of operation. An arrest, 45, reversible engages with the upper mast and lower mast. When the arrest is engaged the relative position of the upper mast is fixed relative to the lower mast. When the arrest is not engaged the upper mast and lower mast are able to slide and therefore the height of the touchscreen surface can be adjusted and fixed at a desired height.

The touchscreen panel is preferably an LCD flat panel with wide view angles is particularly preferred. While not limited thereto a 55 cm (21.5″) screen with an aspect ratio of about 16:9 and viewing angle of about 178° in each direction is optimal for demonstration of the invention. A capacitive touchscreen with at least 5 up to 20 points of touch with about 10 points of touch is optimal for demonstration of the invention. Due to the potential for a harsh environment a protective glass over the screen is particularly preferred. The protective glass is not particularly limited with the understanding that the protective glass does not interfere with the touchscreen functionality.

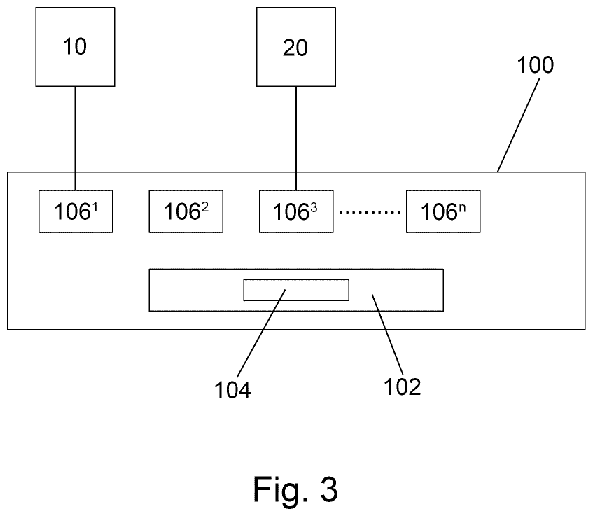

An embodiment of the invention is illustrated in schematic view in FIG. 3. In FIG. 3, the hub, 100, comprises an integral computer, 102, with an operating system, 104, in functional control of the integral computer. Input/Output (I/O) jacks, 106, are in signal communication with the integral computer wherein each I/O jack is capable of signal communication with at least one smart lectern, 10, and at least one touchscreen digital display, 20. Though not limited thereto, I/O jacks in signal communication with the smart lectern are referred to as device I/O jacks and I/O jacks in signal communication with the touchscreen digital display are referred to as display I/O jacks for the purposes of clarity of discussion.

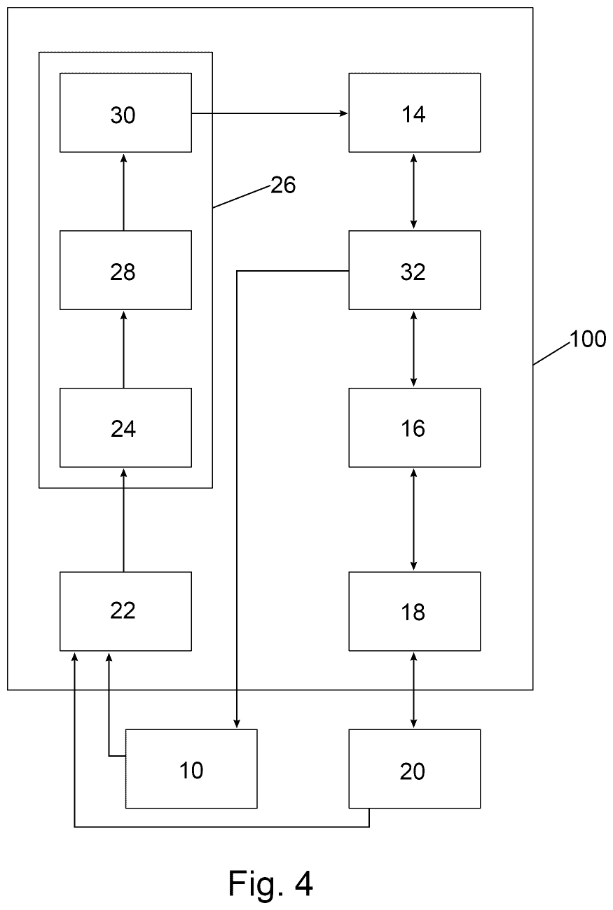

An embodiment of the invention will be described with reference to FIG. 4 wherein the architecture of the hub, 100, is illustrated in a flow chart representation. In FIG. 4, the smart lectern, 10, is in signal communication, preferably touch communication, with a multitouch module switch, 22. As will be realized the multitouch module allows for multiple inputs from different sources. The multitouch module switch is in signal communication, preferably touch communication, with the input system, 24, of the integral computer comprising the operating system, 26. As would be realized the input system of the operating system has integral therewith an input reader, 28, and dispatch module, 30, which provides signal output to the touch process module, 14. The touch process module creates a touch process command which is transmitted to a touch process switch, 32. The touch process command is transmitted to the smart lectern, 10, and to the output driver, 16, for simultaneous display of the same image on the smart lectern and the touchscreen digital display through the touch-out port, 18. Signal communication can include audio, video or image control commands. Touch communication is signal communication comprising touch commands from a digital touch device such as a smart lectern or a touchscreen digital display.

With further reference to FIG. 4, in a parallel process the touchscreen digital display is also in signal communication with the multitouch module switch, 22, which is in signal communication with the operating system, 26, of the display computer. As would be realized from the discussion herein, the operating system, 26, allows any device which is compatible with the operating system to interface with any other compatible device. By switching the signal input at the multitouch module switch, 22, and the touch process switch, 32, the results of touch commands can be simultaneously manipulated by touch command on either the smart lectern or the touchscreen digital device and displayed on both simultaneously.

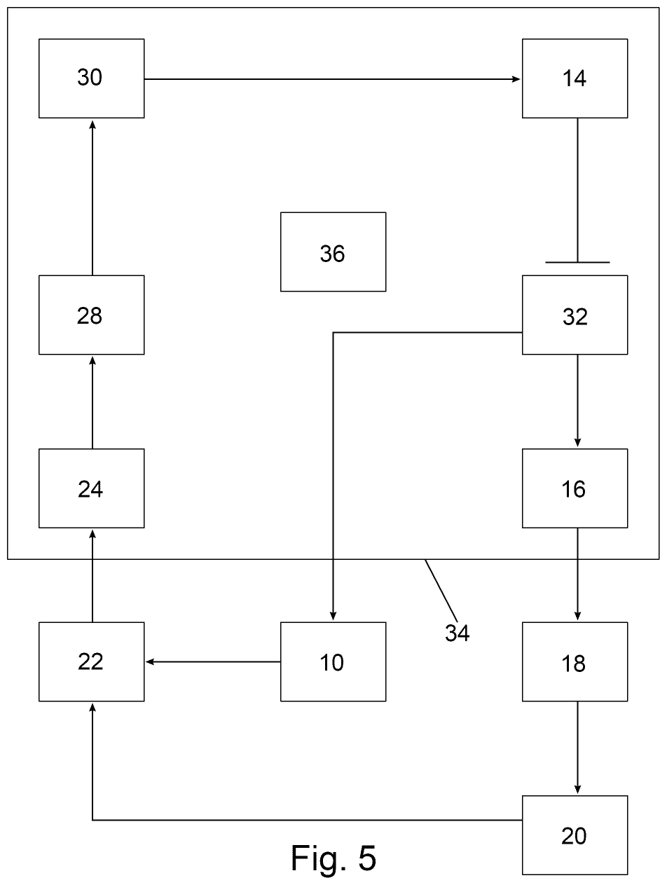

An embodiment of the invention is illustrated schematically in FIG. 5. In FIG. 5 an additional layer of the operating system, 34, comprises an application, 36, wherein the application, referred to in the art as an app, allows for additional functionality on the touchscreen digital display. Layered architecture, the implementation of which is well known in the art, allows for the use of tools include screensharing, annotation, screenshot capabilities, interactive lessons, device management, and collaborating work.

The integral computer of the hub preferably includes a 6000A+ series on-board chip that is capable of operation with all modern audio and video devices. A particularly preferred embodiment comprises a 4k camera and a 6-array microphone to provide state of the art video capabilities for any touchscreen.

A particular advantage of the invention is the ability to utilize different operating systems. Preferred operating systems include Windows loaded on the Intel Pluggable Specification (OPS), Smart Display Module (SDM), macOS or ChromeOS. Most preferably the operating system is Windows loaded on the Intel Pluggable Specification (OPS).

The hub preferably comprises speakers thereby allowing full functionality as a sound bar. Most preferred are high-fidelity, high-volume amplifiers and speakers which provide clarity in larger environments such as those common in classrooms and boardrooms. Speakers which are 6-array speakers are preferable. Speakers coupled with an audio amplifier of at least 15 watts are preferable.

Connectivity is not particularly limited by the invention. Particularly preferred are USB-A, USB-C, HDMI, VGA and other conventional cables due to widespread availability.

To provide further functionality, the invention even allows connection of the OPS computer from the touchscreen panel, or a separate laptop. In this way, all former and current computing functionality is provided through the invention. For example, when connected in this manner, the invention allows for screen capturing, annotation, and touchscreen capability, using the existing glass screen, but all managed by the upgraded computer in the invention.

In a preferred embodiment, the hub utilizes the chipset, software, and EDLA Android 13 ecosystem of 6000A+ panels. This means older touchscreens panels can get a software update, OS update, and feature set upgrade all within a device that far more economical than a replacement. It will also save on E-waste/disposal costs of old technology. Particularly preferred chips for interface with touchscreen devices are RK3588 available commercially from Rockchip Electronics Co. LTD. Particularly preferred is at least an Android 10 version to Android 15 version.

The invention provides the latest software suite to all users. Prior art touchscreens typically did not provide for software upgrades and, when they did, the upgrades were time-consuming and cumbersome. The hub is Internet connected and allows for seamless upgrades.

The shape and size of the hub is not particularly limited with the exception of having sufficient size to allow for the desired number of I/O jacks and, if employed, sufficient facial area for speaker performance. A particular embodiment is sufficiently small to fit into a conventional suitcase for travel. This allows the hub to be mobile and connectible to any available video screen upon arrival, avoiding the need for shipment of a modern touchscreen, while simultaneously providing users the latest audio/video capabilities while traveling. In an embodiment the hub is integral to the smart lectern either as an attachment thereto or integrated into the base and/or mast.

The present invention is compatible with Enterprise Device Licensing Agreement (EDLA) certification requirement which allows for 16 points of touch. EDLA is a collaboration between Google and Android developers to certify a device according to a set of standards. Achieving EDLA has become a standard in and of itself for the IFP industry allowing for the panels to have a complete review by a third party. EDLA certification of the invention allows older touchsource digital displays to be updated to a newer operating system, such as Android OS without prior vulnerabilities.

A touchscreen display manufacturer may provide many proprietary applications and functions that require a specific match between hardware and software, so they design and manufacture their own OPS computers to maximize the functionality of their touchscreens. If a user were to upgrade with a generic OPS computer, the result may be reduced functionality or even complete system failure due to mismatched hardware and software. Unscrupulous users may even upgrade a touchscreen display with a faster but less compatible computer and then attempt to pass it off as a newer model for sale.

In some cases, therefore, the solution is to upgrade the computer using a proprietary adapter to install a new OPS computer. But, where the touchscreen is very old or simply has little to no functionality beyond the glass itself, simply upgrading the computer only provides part of the solution.

Touch points are the number of touch points a screen can recognize simultaneously. A single touch point, for example, would only allow for simple control such as tap, scroll or swipe using a single stylus or finger, for example. With more simultaneous touch points more complex actions can be used such as multiple-finger scrolling, multiple finger expand or zoom, and more complex actions involving multiple fingers, or stylus points, on the screen simultaneously. The number of touch points is not particularly limited herein with the understanding that advances in the number of touch points on a screen will likely continue to grow and therefore the instant invention allows compatibility with increased touch points which was previous difficult to provide.

Elements of the invention not otherwise specified are well known in the art and not necessarily limited herein including memory storage, touch screen technology, power systems and the like. A particular feature of the instant invention is the ability to interface and function with any system compatible with the generic operating system used such as Intel OPS.

The invention has been described with reference to the preferred embodiments without limit thereto. Those of skill in the art may realize additional improvements and embodiments which are not specifically stated but which are within the scope of the invention as set forth in the claims appended hereto.

1. A smart lectern system comprising:
a smart lectern comprising:
a base,
a mast extending from said base; and
a touchscreen panel attached to said mast and capable of generating touch communication; and
a hub capable of receiving said touch communication and transmitting a touch command to an output driver.

2. The smart lectern system of claim 1 wherein said base comprises wheels.

3. The smart lectern system of claim 1 wherein said mast comprises an upper mast and a lower mast wherein said upper mast and said lower mast are slidably engaged.

4. The smart lectern system of claim 3 wherein said upper mast and said lower mast are telescoping.

5. The smart lectern system of claim 4 further comprising a lift assist integral to said upper mast and said lower mast.

6. The smart lectern system of claim 4 further comprising an arrest for fixing said upper mast and said lower mast in fixed relative position.

7. The smart lectern system of claim 1 further comprising a touchscreen surface.

8. The smart lectern system of claim 7 wherein said touchscreen panel is integral to said touchscreen surface.

9. The smart lectern system of claim 1 further comprising a microphone.

10. The smart lectern system of claim 1 wherein said touchscreen panel is a capacitive touchscreen.

11. The smart lectern system of claim 1 wherein said touchscreen panel as at least 5 up to 20 points of touch.

12. The smart lectern system of claim 1 wherein said touchscreen panel comprises a protective glass.

13. The smart lectern system of claim 1 wherein said hub is integral to said smart lectern.

14. The smart lectern system of claim 1 wherein said hub further comprises a multitouch module switch capable of receiving multiple touch communications for transmitting to said output driver.

15. The smart lectern system of claim 14 wherein said multiple touch communications are from said touchscreen panel and a touchscreen digital display.

16. The smart lectern system of claim 14 wherein said hub further comprises an operating system capable of receiving said multiple touch communications and transmitting said touch command to a touch process switch wherein said touch process switch transmits said touch command to at least one of said smart lectern or a touchscreen digital display.

17. The smart lectern system of claim 16 wherein said operating system is selected from the group consisting of Intel Pluggable Specification and Smart Display Module.

18. The smart lectern system of claim 17 wherein said operating system is an Android operating system.

19. The smart lectern system of claim 17 wherein said Android operation system is Android 10 version to Android 15 version.

20. The smart lectern system of claim 16 wherein said operating system further comprises an application layer.

21. The smart lectern system of claim 20 wherein said application layer is selected from the group consisting of screensharing, annotation, screenshot, interactive lessons, device management, and collaborating work

22. The smart lectern system of claim 1 wherein said hub further comprises an output port capable of transmitting said touch command from said output driver to a digital touchscreen digital display.

23. The smart lectern system of claim 1 comprising a series 6000A+ chip.

24. The smart lectern system of claim 1 further comprising at least one input/output connected selected from the group consisting of USB-A, USB-C, HDMI and VGA.

25. The smart lectern system of claim 1 further comprising at least one of a speaker and a video camera.

26. A smart lectern system comprising:
a smart lectern comprising:
a base,
a mast extending from said base; and
a touchscreen panel attached to said mast and capable of generating a first touch communication;
a hub comprising:
in input system capable of receiving said first touch communication;
a computer comprising an operating system capable of receiving said touch communication and transmitting signal output to a touch process module wherein said touch process module generates a touch process command; and
a digital display device capable of receiving said touch process command and displaying an image.

27. The smart lectern system of claim 26 further comprising a multitouch module switch capable of receiving said first touch command and a second touch command from said digital display device.

28. The smart lectern system of claim 26 further comprising a touch process switch capable transmitting said touch command to said digital display device and to said touchscreen panel.

29. The smart lectern system of claim 26 wherein said base comprises wheels.

30. The smart lectern system of claim 26 wherein said mast comprises an upper mast and a lower mast wherein said upper mast and said lower mast are slidably engaged.

31. The smart lectern system of claim 30 wherein said upper mast and said lower mast are telescoping.

32. The smart lectern system of claim 31 further comprising a lift assist integral to said upper mast and said lower mast.

33. The smart lectern system of claim 31 further comprising an arrest for fixing said upper mast and said lower mast in fixed relative position.

34. The smart lectern system of claim 26 further comprising a touchscreen surface.

35. The smart lectern system of claim 34 wherein said touchscreen panel is integral to said touchscreen surface.

36. The smart lectern system of claim 26 further comprising a microphone.

37. The smart lectern system of claim 26 wherein said touchscreen panel is a capacitive touchscreen.

38. The smart lectern system of claim 26 wherein said touchscreen panel as at least 5 up to 20 points of touch.

39. The smart lectern system of claim 26 wherein said touchscreen panel comprises a protective glass.

40. The smart lectern system of claim 26 wherein said hub is integral to said smart lectern.

41. The smart lectern system of claim 26 wherein said hub further comprises a multitouch module switch capable of receiving multiple touch communications for transmitting to said output driver.

42. The smart lectern system of claim 41 wherein said multiple touch communications are from said touchscreen panel and a touchscreen digital display.

43. The smart lectern system of claim 41 wherein said hub further comprises an operating system capable of receiving said multiple touch communications and transmitting said touch command to a touch process switch wherein said touch process switch transmits said touch command to at least one of said smart lectern or a touchscreen digital display.

44. The smart lectern system of claim 26 wherein said operating system is selected from the group consisting of Intel Pluggable Specification and Smart Display Module.

45. The smart lectern system of claim 44 wherein said operating system is an Android operating system.

46. The smart lectern system of claim 43 wherein said Android operation system is Android 10 version to Android 15 version.

47. The smart lectern system of claim 43 wherein said operating system further comprises an application layer.

48. The smart lectern system of claim 47 wherein said application layer is selected from the group consisting of screensharing, annotation, screenshot, interactive lessons, device management, and collaborating work

49. The smart lectern system of claim 26 wherein said hub further comprises an output port capable of transmitting said touch command from said output driver to a digital touchscreen digital display.

50. The smart lectern system of claim 26 comprising a series 6000A+ chip.

51. The smart lectern system of claim 26 further comprising at least one input/output connected selected from the group consisting of USB-A, USB-C, HDMI and VGA.

52. The smart lectern system of claim 26 further comprising at least one of a speaker and a video camera.
